(19) United States
(12) Patent Application Publication
(10) Pub. No.: US 2022/0118627 A1
(43) Pub. Date: Apr. 21, 2022

(54) APPARATUS TO PREPARE FOOD AND METHOD FOR USE

(71) Applicant: Picnic Works, Inc., Seattle, WA (US)

(72) Inventor: Timothy Talda, SEATTLE, WA (US)

(21) Appl. No.: 17/516,387

(22) Filed: Nov. 1, 2021

Related U.S. Application Data
(63) Continuation-in-part of application No. 16/360,279, filed on Mar. 21, 2019, now Pat. No. 11,252,970.
Application No. 16/360,279 is a continuation-in-part of application No. 16/360,487, filed on Mar. 21, 2019, now Pat. No. 11,202,533.

(51) Int. Cl. B25J 11/00; B25J 15/00; B25J 9/00; B25J 9/16; A23P 20/18

(52) U.S. Cl. CPC B25J 11/0045; B25J 15/0019; A23P 20/18; B25J 9/1661; B25J 9/1697; B25J 9/0096

(57) ABSTRACT

The present invention relates to apparatus and methods for assembling food products. More particularly, the invention relates to apparatus and methods for associating foodstuff and liquid with a base. Foodstuff may include food items such as meats, vegetables, cheeses, amongst others. Liquids include those food items that have a low viscosities (e.g. sauces, dressings, oils), high viscosities (e.g. peanut butter, frosting), and anything in between. A base can be anything on which foodstuff or liquid may be associated (e.g. bread, cake, cookies, pizza dough, a bowl in which to place foodstuff).

### CROSS-REFERENCES TO RELATED APPLICATIONS

This Application takes priority to U.S. application Ser. Nos. 16/360,279 and 16/360,487, both filed on Mar. 21, 2019, and hereby incorporated by reference.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND

The present invention relates to apparatus and methods for assembling food products. More particularly, the invention relates to apparatus and methods for associating foodstuff and liquid with a base. Foodstuff may include food items such as meats, vegetables, cheeses, amongst others. Liquids include those food items that have low viscosities (e.g. sauces, dressings, oils), high viscosities (e.g. peanut butter, frosting), and anything in between. A base can be anything on which foodstuff or liquid may be associated (e.g. bread, cake, cookies, pizza dough, a bowl in which to place foodstuff).

In a commercial kitchen, the process of associating foodstuff to a base is labor intensive and expensive. Consider, for example, assembling a pizza. Pizza dough must be prepped and formed into the correct size base and a specified amount of sauce and bulk ingredients (e.g. mushrooms, olive, pepperoni, green peppers, amongst others) must be applied to the base.

The application of a specified amount of sauce and bulk ingredient is important for a few reasons. First, a specified amount of sauce and bulk ingredients allows diners to have a consistent experience. If, for a cheese pizza, for example, a three to one cheese to sauce ratio provides the best dining experience, then each time that pizza is ordered the three to one ratio should be used. Second, the amount of sauce and bulk ingredients delivered to a base will determine the profit margin for a pizza. If too much sauce and bulk ingredients are delivered to a base, profit margins will be lower or lost. If too little sauce and bulk ingredients are delivered to a base, customers may be lost. In both of these scenarios, tolerance for error is low.

There is a need for a fully automated, easy to operate, apparatus which consistently; associates foodstuff and liquid with a base. Such an apparatus may be used as an operator-assisted, diner operated, or stand-alone vending machine, which may be used on campuses, cafeterias, commissaries, etc.; a kitchen operated machine which can be operated by a cook, for example; amongst others.

### BRIEF DESCRIPTION OF INVENTION

A general object of the invention is to provide an automated, self-contained system apparatus to associate foodstuff or liquid with a base.

Another object of the invention is to provide an apparatus to distribute liquid that provides a defined amount of liquid at a prescribed location.

Another object of the invention is to provide an apparatus to distribute foodstuff. That provides a defined amount of foodstuff at a prescribed location.

Another object of the invention is to provide an apparatus in which foodstuff and/or liquid may be preselected by a diner and cooked an amount which is dependent upon the selected foodstuff and/or base.

### DESCRIPTION OF THE SEVERAL VIEWS OF THE DRAWINGS

Other features and advantages of the present invention will become apparent in the following detailed descriptions of the preferred embodiment with reference to the accompanying drawing.

FIG. 1A is a block diagram of an embodiment of apparatus for a self-contained system to associate foodstuff and/or liquid with a base;

FIG. 1B is a block diagram of an embodiment of apparatus for a self-contained system to associate foodstuff and/or liquid with a base;

FIG. 2 is a front view of an embodiment of the liquid distribution station;

FIG. 3 is a perspective view of an embodiment of the liquid distribution station;

FIG. 4 is a top view of an embodiment of the liquid distribution station;

FIG. 5 is a bottom view of an embodiment of the liquid distribution station;

FIG. 6 is a perspective view of an embodiment of the foodstuff distribution station;

FIG. 7 is a top view of an embodiment of the foodstuff distribution station;

FIG. 8 is a perspective view of an embodiment of the cheese grater and distribution station;

FIG. 9 is a perspective view of an embodiment of the meat slicer and distribution station;

FIG. 10 is a front view of an embodiment of the granular foodstuff distribution station;

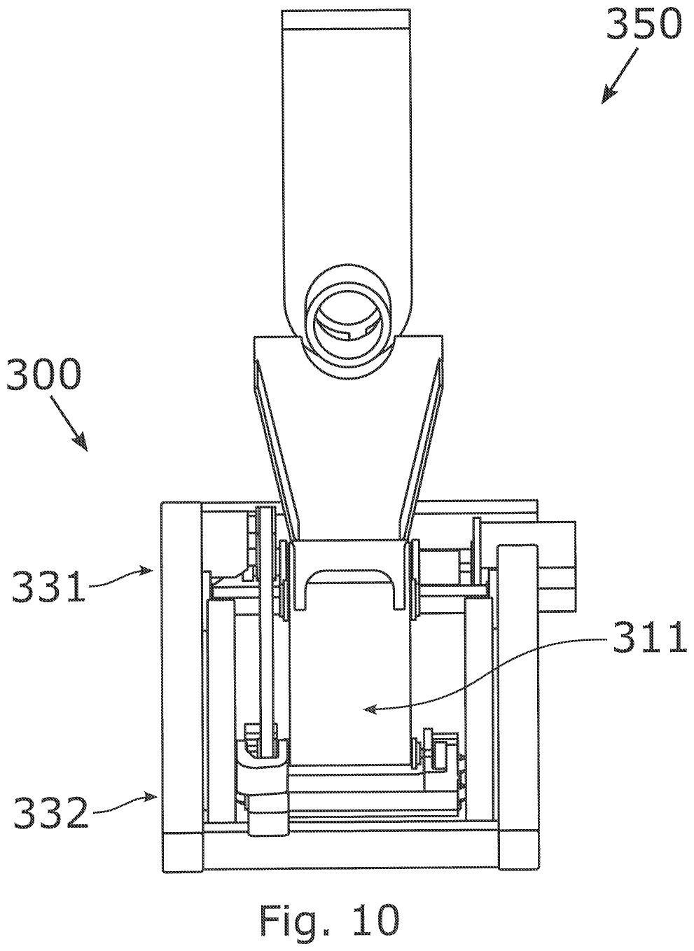

FIG. 11 is a front view of an embodiment of the granular foodstuff distribution station;

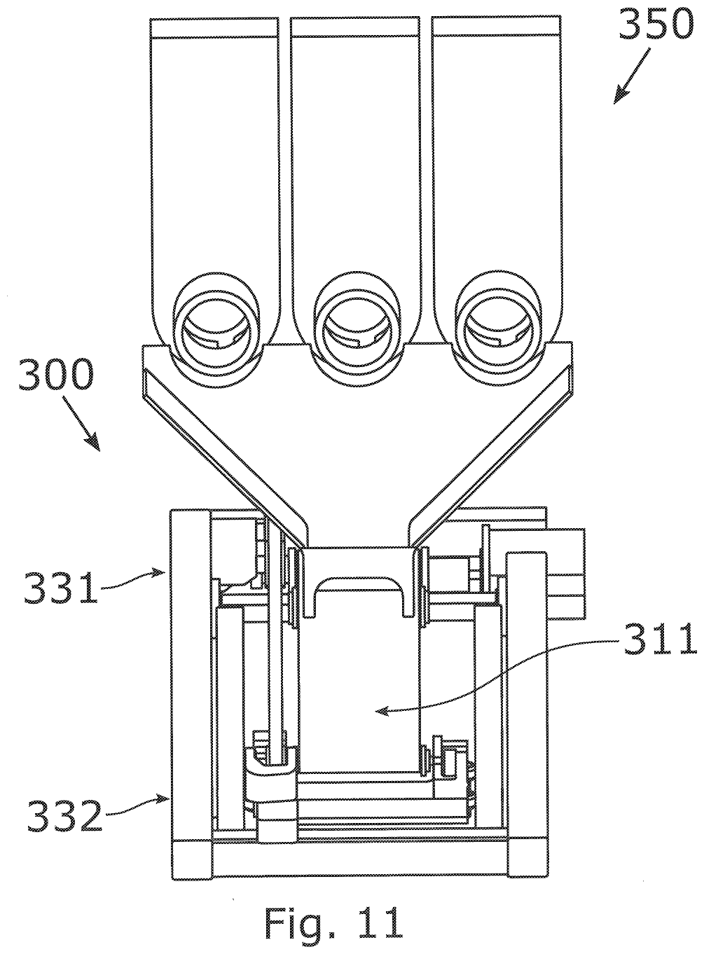

FIG. 12 is a perspective view of an embodiment of the granular foodstuff container;

FIG. 13 is an exploded view of an embodiment of the granular foodstuff container;

FIG. 14 is a side view of an embodiment of the handler;

FIG. 15 is a flow chart showing an embodiment of a control system for the apparatus for a self-contained system to associate foodstuff and/or liquid with a base;

FIG. 16 shows a vehicle is which the apparatus for a self-contained system to associate foodstuff and/or liquid with a base is located.

### DETAILED DESCRIPTION OF THE INVENTION

In the following detailed description, reference is made to the accompanying drawings, which form a part hereof. In the drawings, the use of similar or the same symbols in different drawings typically indicates similar or identical items, unless context dictates otherwise.

The illustrative embodiments described in the detailed description, drawings, and claims are not meant to be limiting. Other embodiments may be utilized, and other changes may be made, without departing from the spirit or scope of the subject matter presented here.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken as limiting.

The present application uses formal outline headings for clarity of presentation. However, it is to be understood that the outline headings are for presentation purposes, and that different types of subject matter may be discussed throughout the application (e.g., device(s)/structure(s) may be described under process(es)/operations heading(s) and/or process(es)/operations may be discussed under structure(s)/process(es) headings; and/or descriptions of single topics may span two or more topic headings). Hence, the use of the formal outline headings is not intended to be in any way limiting. Given by way of overview, illustrative embodiments include apparatus for a self-contained system to associate foodstuff and/or liquid with a base (“system”) (100) and methods.

In one example, the base may be bread and the liquid may include a condiment, and the foodstuff maybe deli meat. In another example, the base may be a cookie and the liquid may be frosting. In another example, the base may be a bowl and the foodstuff may be greens for a salad and the liquid may be a salad dressing. Exemplary embodiments are discussed below.

In the following specifications, reference will be made to food translating systems. One embodiment of a food translating system is comprised of at least two pulleys, with an endless loop of carrying medium—the conveyor belt or belts—that is rotated by pulleys. One or both of the pulleys are powered moving the belt or belts and the material on the belt(s) in a defined direction. The powered pulley is called the drive pulley while the unpowered pulley is called the idler pulley. Generally, the powered pulley is motor driven. The motor may be an electric motor, air motor, hydraulic motor, amongst others. In other embodiments, the food translating system may utilize chains, pneumatics, hydraulics, or other electro-mechanical motion control systems, amongst other.

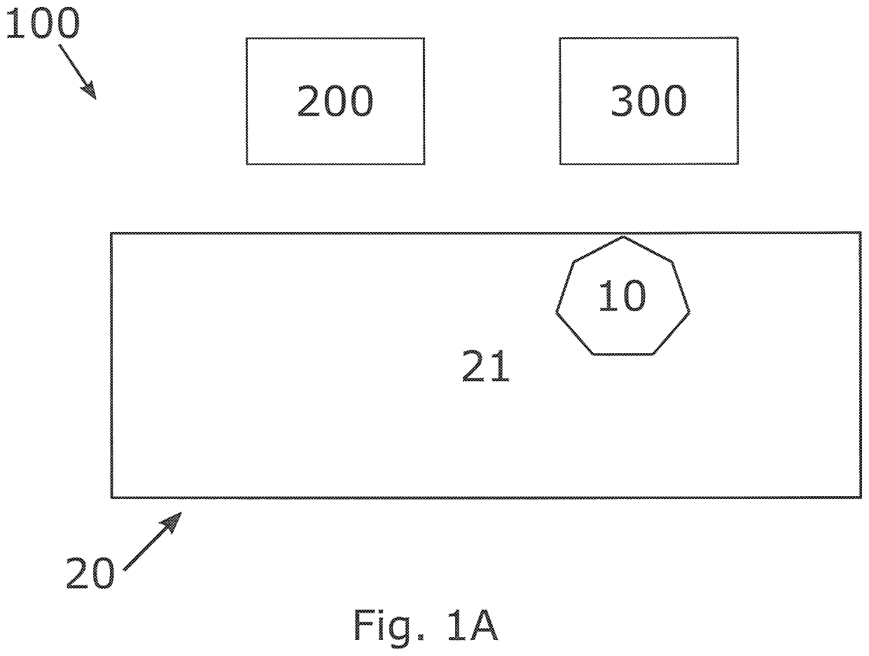

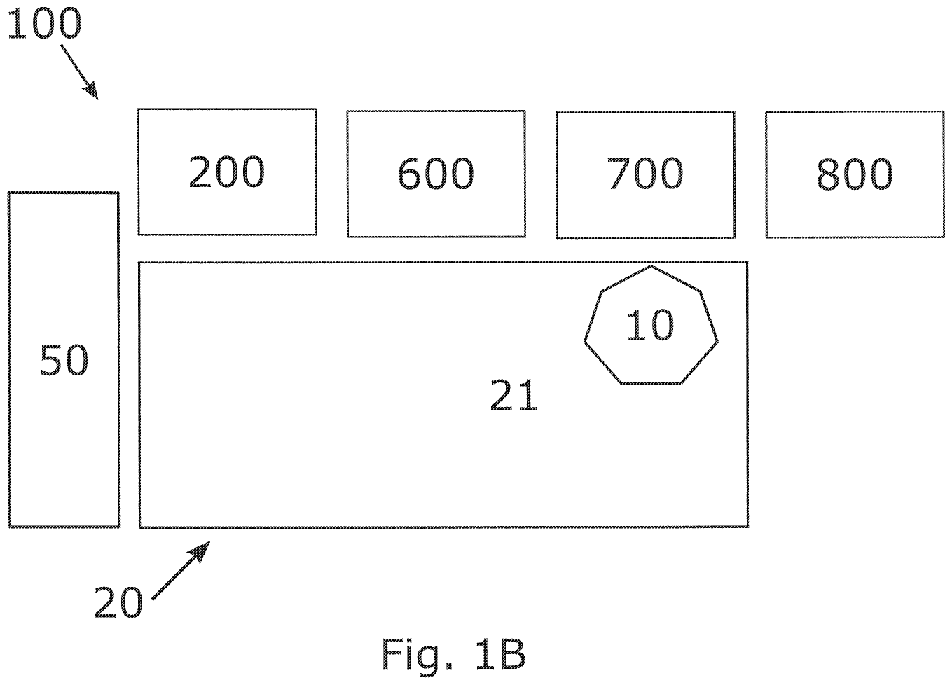

Referring to FIG. 1A, in an embodiment, the (100) is comprised of a main food translating system (20) having at least one conveyor belt (21) and at least one distribution station chosen from the set consisting of an apparatus to distribute liquid (or liquid distribution station) (200) and an apparatus to distributed foodstuff (or foodstuff distribution station) (300). Although two distribution stations (200, 300) are shown, it will be obvious that the apparatus (100) may have any number of distribution stations in any combination. In an embodiment, at least a portion of the distribution station may be located within a refrigerator or may be refrigerated.

In embodiments, a plurality of bases (10) may be sequentially loaded onto the main conveyer belt (21). In one embodiment, the main conveyor belt (21) may be heated or cooled; allowing a base (10) to cook/thaw or chill, for example, as it travels along the main conveyor belt (21). In an embodiment, the temperature of the main conveyor belt (21) may vary over time or location. In an embodiment, at least one heating or cooling source may be provided under the main conveyor belt (21) allowing a base (10) to cook/thaw or chill, for example, as it travels along the main conveyor belt (21). Base (10) are conveyed on the main conveyor belt (21) so that at least one distribution station (200, 300) can associate foodstuff and/or liquid bases (10). In an embodiment, the main conveyor belt (21) may incline or decline towards or away from at least one distribution station (200, 300).

In an embodiment, the main conveyer belt system (20) is comprised of a single conveyor passing beneath each distribution station (200, 300). In another embodiment, the main food translating system (20) may be comprised of several interconnected conveyor sections.

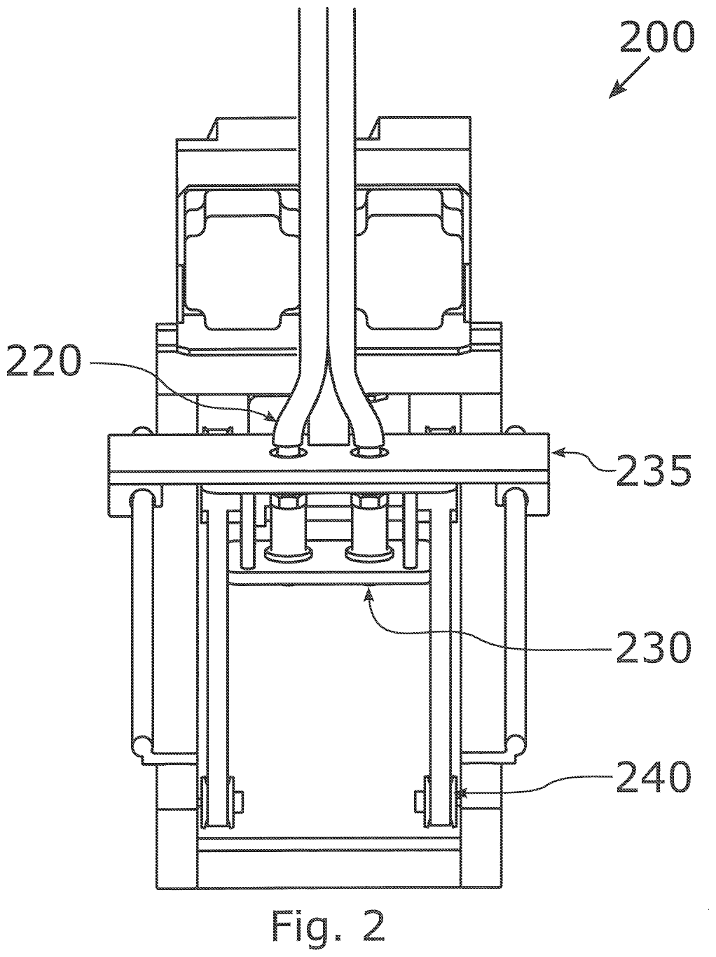

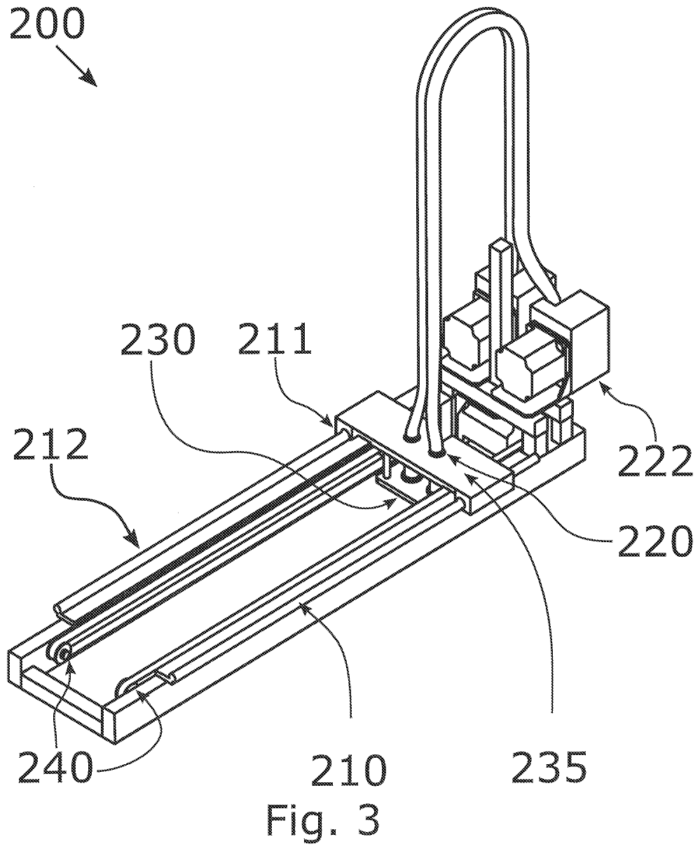

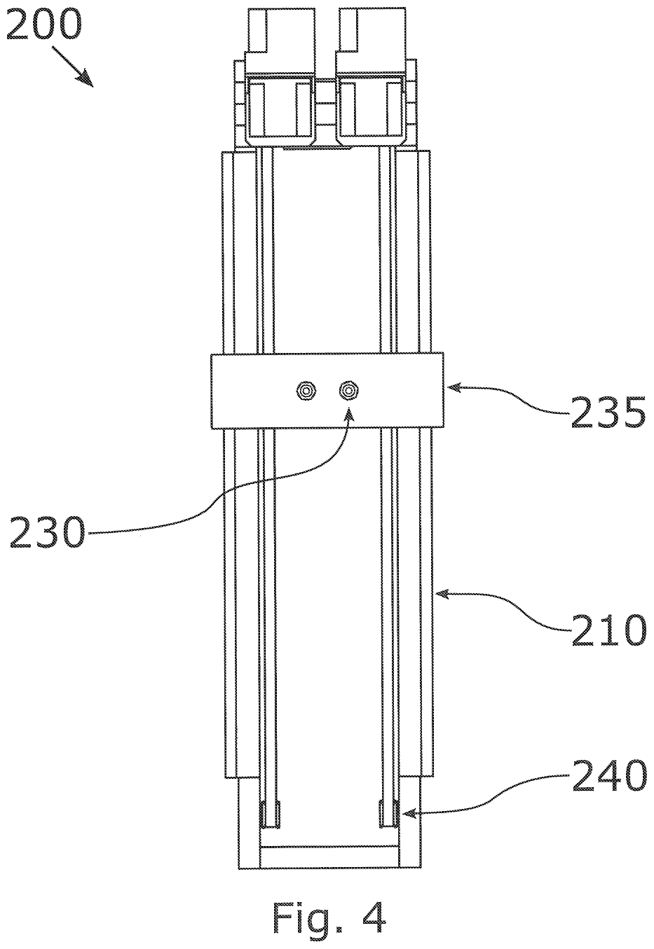

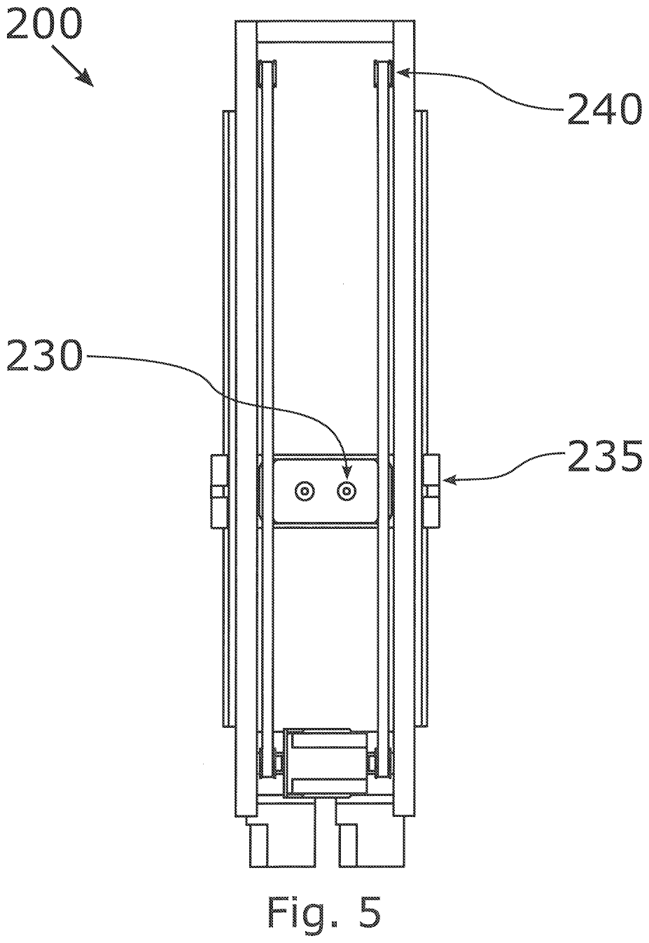

Referring to FIGS. 2 through 5, in an embodiment, the liquid distribution system (200) is comprised of at least one set of liquid distribution tracks (210) and at least one conduit (220) that provides liquid to at least one liquid dispensing mechanism (230). In an embodiment, the dispensing mechanism is a nozzle. In an embodiment, the conduit (220) is in fluid communication with a container (not shown) that holds the liquid that is to be associated with a base. In an embodiment, a pumping mechanism (222) moves fluid from the container through the conduit (220) into the liquid dispensing mechanism (230). In an embodiment, the pumping mechanism (222) is a peristaltic pump.

The liquid dispensing mechanism (230) is operably connected to the liquid distribution tracks (210) so as to allow movement of the liquid dispensing mechanism (230) along the liquid distribution tracks (210). The liquid dispensing mechanism (230) is operably connected to a using any of pulleys, chains, pneumatics, hydraulics, or other electro-mechanical motion control systems, amongst others (240) which enables the movement of the liquid dispensing mechanism (230) along the liquid distribution tracks or guides (210).

According to an embodiment, the liquid dispensing mechanism (230) is supported by a frame (235). The frame (235) is operably mated to the liquid distribution tracks (210). According to an embodiment, the frame (235) is operably connected to a motorized pulley system (240) which enables movement of the liquid dispensing mechanism (230) along the liquid distribution tracks (210).

According to an embodiment, the liquid distribution tracks (210) are configured to lie approximately perpendicular to the main conveyor belt (21). According to an embodiment, the movement of the liquid dispensing mechanism (230) is timed so that when the conveyor belt (21) moves a base (10) underneath the liquid distribution station (200) the liquid dispensing mechanism (230) moves from a first location (211) on the liquid distribution tracks (210) to a second location (212) along the liquid distribution tracks (210); releasing liquid while in motion from the first location (211) to the second location (212) to associate liquid with the base (10). In one embodiment, the position of first location (211) and/or the second location (212) relative to the liquid distribution tracks (210) may vary as the base moves along the main conveyor belt (21) allowing liquid to be deposited in varying patterns.

According to an embodiment, the liquid dispensing mechanism (230) a first location (211) and a second location (212) relative to the liquid distribution tracks (210) maybe dependent on the size or location of the base (10) or the type of liquid to be distributed over a base (10). According to an embodiment, the movement of the liquid dispensing mechanism (230) is controlled by computer numerical control or other software that provides a similar function.

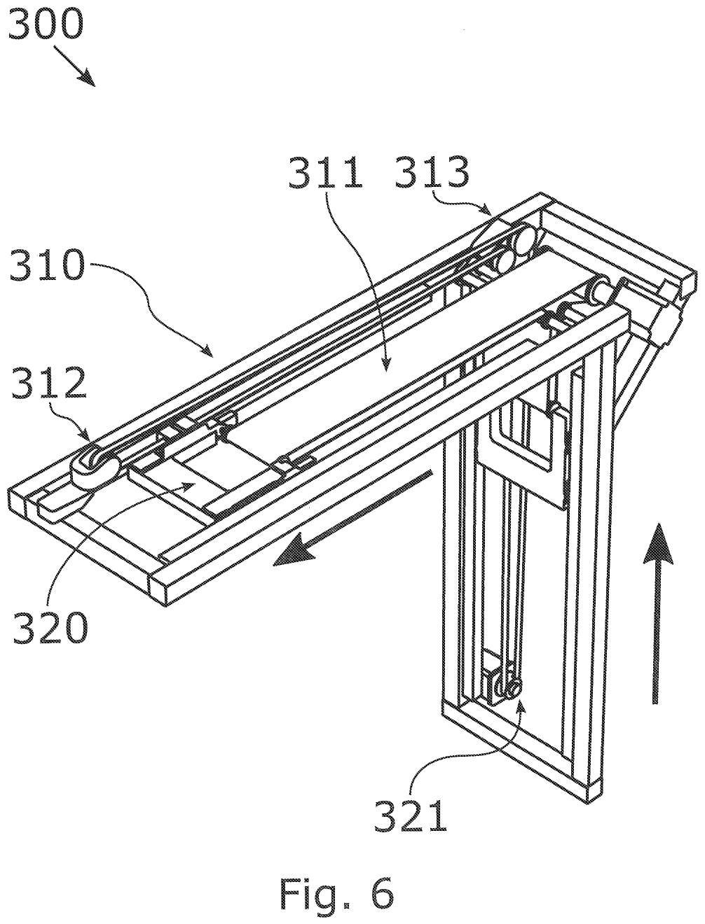

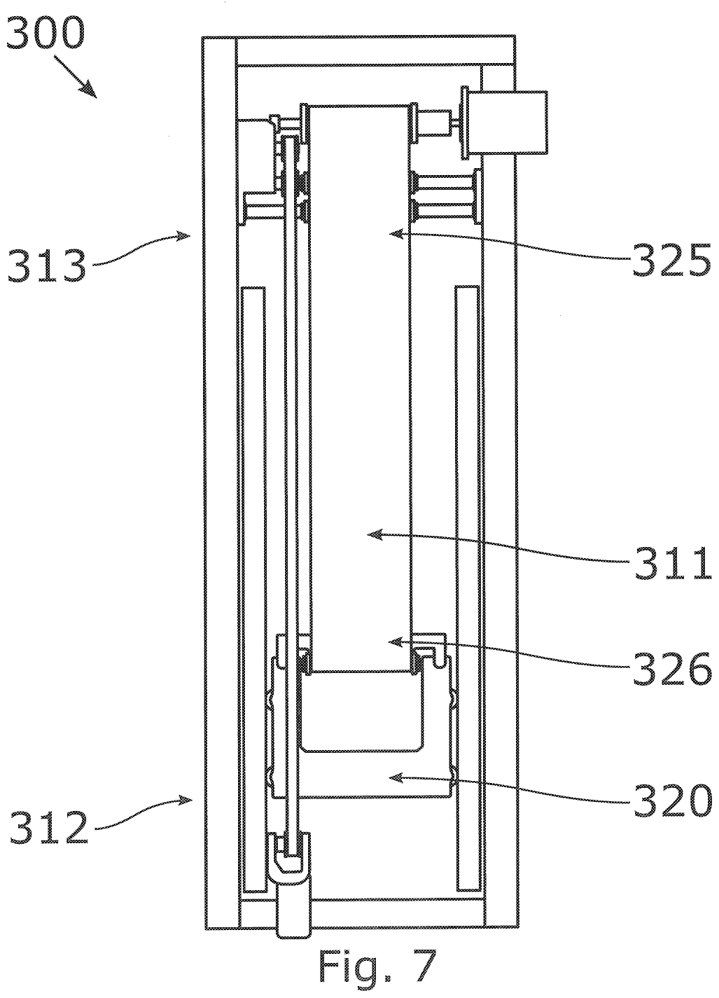

Referring to FIGS. 6 and 7, non-liquid foodstuff may be associated with a base (10) using a foodstuff distribution station (300). According to an embodiment the foodstuff distribution station (300) is comprised of a foodstuff conveyor belt system (310) having at least one food stuff conveyor belt (311) and a carriage (320). The carriage (320) is comprised of a motor and pully system (321) allowing it to move from a first location (313) to a second location (312).

The foodstuff conveyor belt (311) is comprised of a near end (325) and a far end (326). The foodstuff conveyor belt (311) is operably attached to the carriage (320) so that when the carriage (320) moves from a first location (313) to a second location (312) the foodstuff conveyor belt (311) moves from the first location (313) to the second location (312) while continuing to operate. According to one embodiment, when the carriage (320) moves from the second location (312) to the first location (313), the foodstuff conveyor belt (311) is locked so that it is no longer operating. In another embodiment, when the conveyor belt (311) moves from the first location (313) to the second location (312) the speed of the foodstuff conveyor belt (311) is modulated. In another embodiment, when the conveyor belt (311) moves from the second location (312) to the first location (313), the speed of the foodstuff conveyor belt (311) is modulated. In another embodiment, the speed of the foodstuff conveyor belt (311) is continually modulated.

According to an embodiment, the foodstuff conveyor belt (311) is located approximately perpendicular to the main conveyor (21). According to an embodiment, as foodstuff conveyor belt (311) is timed to deliver foodstuff to a base (10) as it passes under the foodstuff distribution station (300). According to an embodiment, the speed of the foodstuff conveyor belt may vary depending on the size or location of the base (10) or the type of foodstuff to be distributed over a base (10). According to an embodiment, the movement of the foodstuff distribution station (300) is controlled by computer numerical control or other software that provides a similar function.

According to an embodiment, when the carriage (320) moves from the first location (313) to the second location (312), foodstuff is associated with the foodstuff conveyor belt (311). The carriage (320) is then moved from the second location (312) to the first location (313) and the food stuff conveyor belt (311) is prevented from operating; consequently, foodstuff is associated with the base (10). According to an embodiment, the carriage (320) may have a plurality of first locations (313) and a plurality of second locations (312).

In one embodiment, the foodstuff conveyer belt (311) is a single conveyor. In another embodiment, the foodstuff conveyor belt (311) may be comprised of several interconnected conveyor sections.

In an embodiment, foodstuff distribution station may be a delta robot where the delta robot is comprised of at least one camera. In an embodiment, the camera will see and determine the size and shape of a base (10). The delta robot compares the seen size and shape of the base (10) against a pre-recognized shape or size. The delta robot will calibrate placement of foodstuff relative to the comparison.

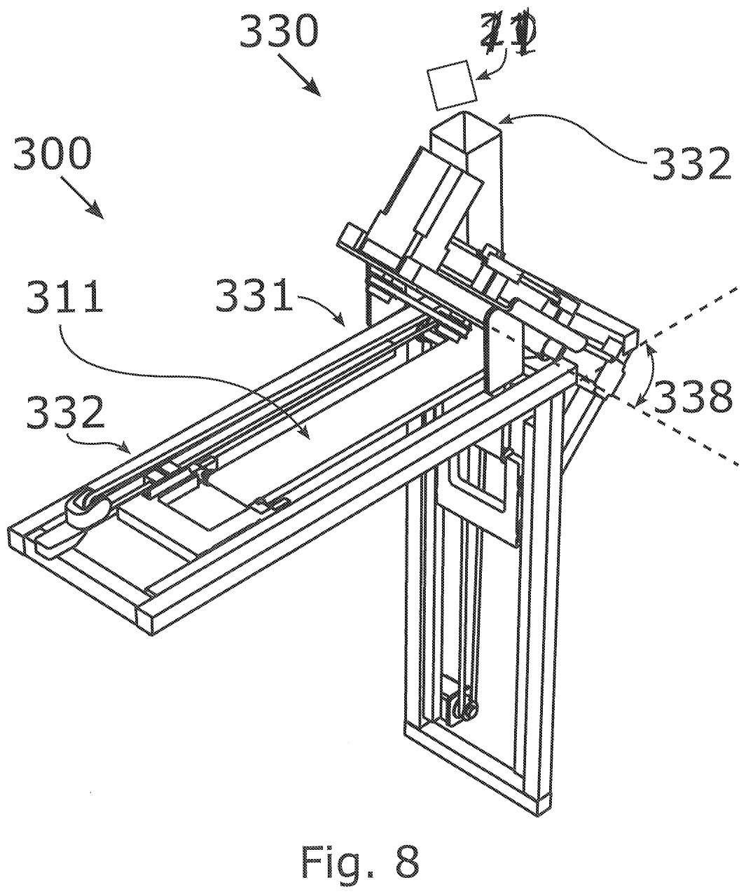

Referring to FIGS. 6 through 8, according to one embodiment, the foodstuff distribution station (300) may be operably attached to a shredder (330). The foodstuff distribution station (300) has a near end (331) and a far end (332). According to an embodiment, the shredder (330) is operably attached to the near end (331) of the foodstuff distribution station (300) with a commonly known fastening system. According to one embodiment, the shredder (330) is operably attached to the near end (331) of the foodstuff distribution station (300) at an angle (338) between 10° and 90° relative to the foodstuff conveyor belt (311) which is approximately horizontal. Although a disk shredder is shown in drawings for exemplary purposes, the shredder can be any other apparatus that accepts foodstuff and associates the foodstuff to the foodstuff conveyor belt (311) in a smaller portion by slicing, dicing, or otherwise cutting the foodstuff.

According to an embodiment, the shredder (330) may be cooled by an external or internal heat exchange system. According to an embodiment, a conduit (332) may be located near or operably attached to the shredder (330) or foodstuff distribution station (300) allowing delivery of foodstuff (21) to the shredder. According to an embodiment, the foodstuff (21) delivered to the shredder (330) is cheese. Referring to FIG. 1B, for exemplary purposes, this is called the cheese distribution station (600) below.

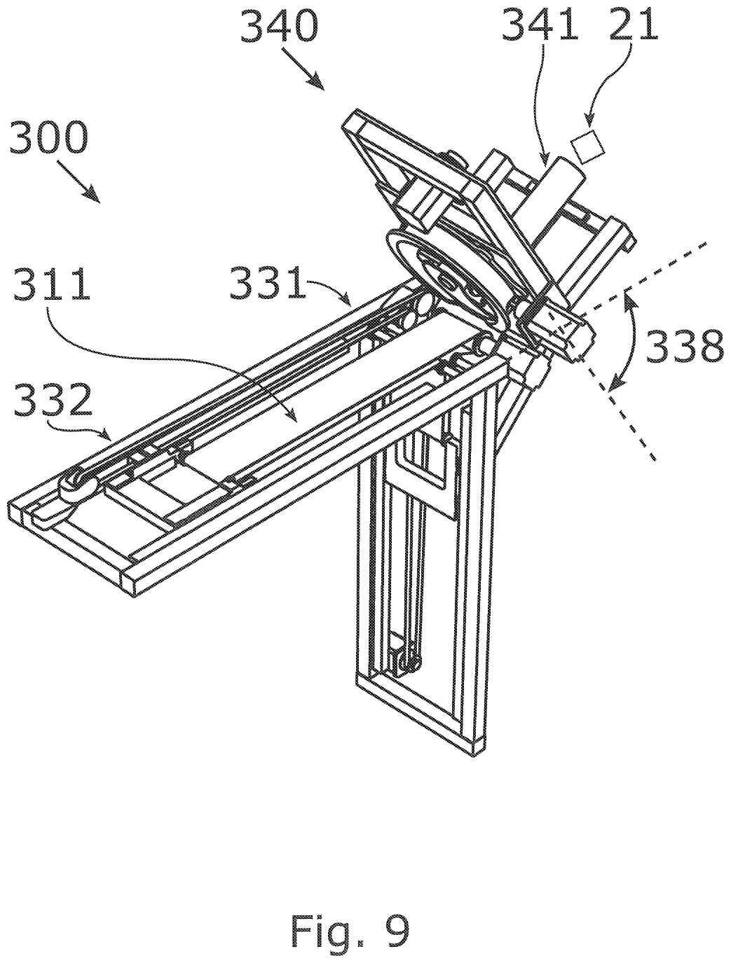

Referring to FIGS. 6, 7, 8, and 9, according to one embodiment, the foodstuff distribution station (300) may be operably attached to a slicer (340). The foodstuff distribution station (300) may have a near end (331) and a far end (332). According to an embodiment, the slicer (340) is operably attached to the near end (331) of the foodstuff distribution station (300) with a commonly known fastening system. According to one embodiment, the slicer (340) is operably attached to the near end (331) of the foodstuff distribution station (300) at an angle (338) between 10° and 90° relative to the foodstuff conveyor belt (311) which is approximately horizontal. According to an embodiment, the slicer may slice foodstuff to various thicknesses. Although a slicer is shown in drawings for exemplary purposes, the slicer (340) can be any apparatus that accepts foodstuff and associates the foodstuff to the foodstuff conveyor belt (311) in a smaller portion by slicing, dicing, or otherwise cutting the foodstuff.

According to an embodiment, the slicer (340) may be cooled by an external or internal heat exchange system. According to an embodiment, a conduit (341) may be located near or operably attached to the slicer (340) allowing delivery of foodstuff (21) to the slicer (340). According to an embodiment, the foodstuff (21) delivered to the slicer (340) is pepperoni or other meat. Referring to FIG. 1B, for exemplary purposes, this is called the meat distribution station (700) below.

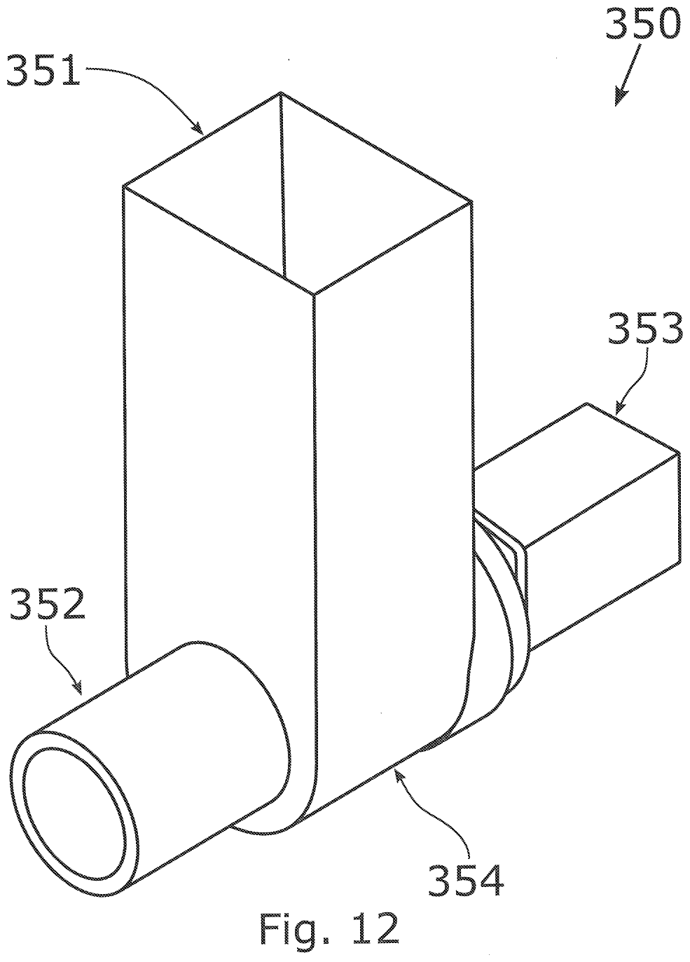

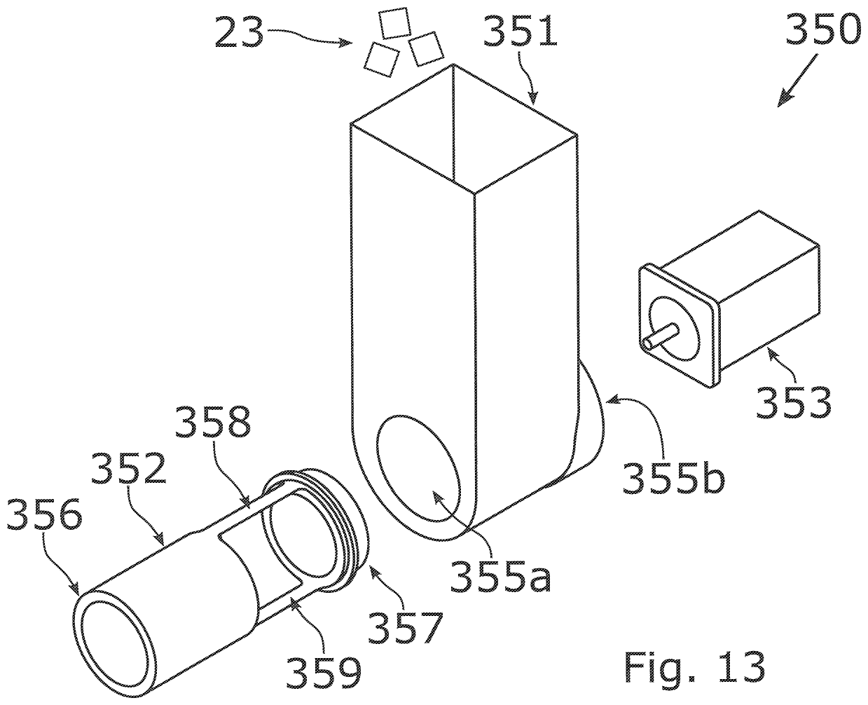

Referring to FIGS. 6, 7, 8, 12, and 13, according to one embodiment, the foodstuff distribution station (300) may be operably attached to at least one foodstuff container (350). The foodstuff distribution station (300) may have a near end (331) and a far end (332). According to an embodiment, the foodstuff container (350) is operably attached to the near end (331) of the foodstuff distribution station (300) with a commonly known fastening system. According to an embodiment, the foodstuff container (350) is located at the near end (331) of the food stuff distribution station (300) allowing foodstuff from the foodstuff container (350) to associate with the foodstuff conveyor belt (311).

According to an embodiment, the foodstuff container (350) is comprised of a foodstuff conduit (351), a barrel (352), and motor (353). The foodstuff conduit (351) has a top portion (354) and a bottom portion (355). The bottom portion (355) of the foodstuff conduit (351) defines female end (355a) and female end (355b).

The barrel (352) has a near end (357) and a far end (356). The near end (357) of the barrel (352) operably mates with female end 355aof the foodstuff conduit (351). The motor (353) operably mates with the female end 335b of foodstuff conduit (351) so as to rotate barrel (352).

According to an embodiment, the near end (357) of the barrel (352) defines a cutaway to form at a set of beater bars or fins (358, 359). In some embodiments, the barrel (352) may be replaced by an egg beater or whisk.

Foodstuff (23) is passed from the foodstuff conduit (351) through the barrel (352) onto the foodstuff conveyor belt (311). The fins (358, 359) prevent clumping of foodstuff (23) by separating the foodstuff as it is associated with the foodstuff conveyor belt (311).

According to an embodiment, the foodstuff (23) delivered from the container (350) to the foodstuff conveyor belt (311) may be onions, peppers, olives, amongst others. According to an embodiment, a plurality of containers (350) maybe operably associated with the foodstuff conveyor belt (311). Referring to FIG. 1B, for exemplary purposes, this is called the granular delivery system (800) below.

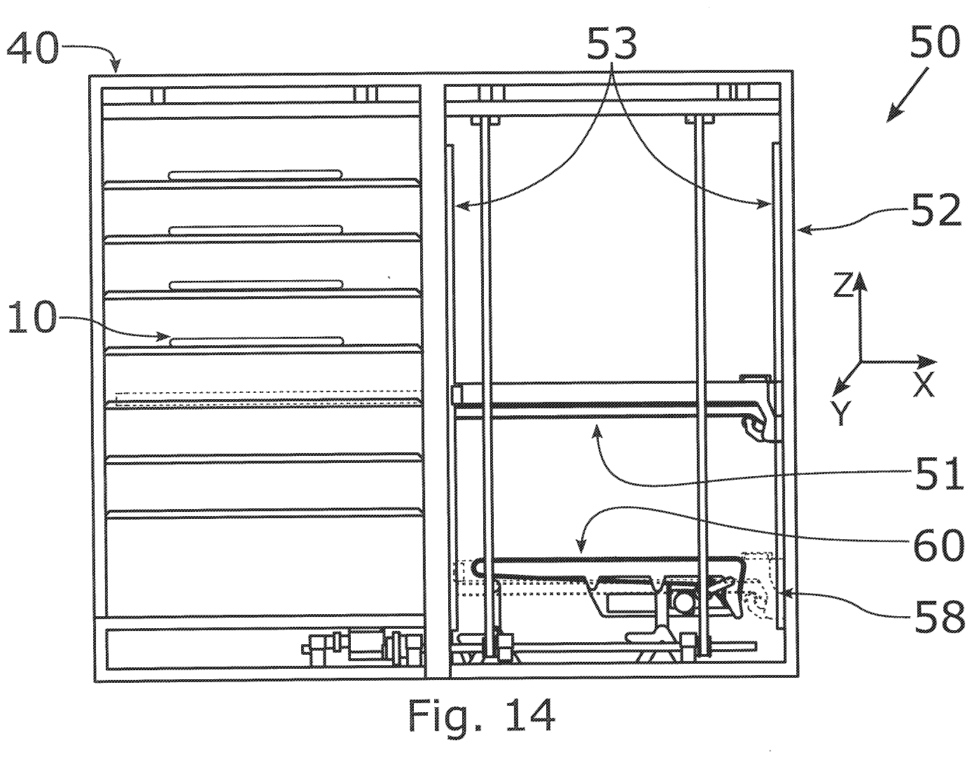

Referring to FIGS. 1A and 14, in an embodiment, the self-contained apparatus to associate foodstuff and/or liquid with a base (100) is further comprised of base handler (50). In an embodiment, a base (10) is removed from a storage location (40) and placed onto the main conveyor (20) by a base handler (50).

In an embodiment, the base handler (50) is comprised of a panel (51) which is operably connected to a motorized pulley system (58) that allows the panel (51) to move along the x-, y- and z-axis. In an embodiment, the panel (51) is operably attached to a frame (52) which provides tracks (53) on which the panel (51) may move; whereby the frame (52) supports panel (51). The panel (51) moves along the frame (52) in the x-, y-, or z-axis, utilizing the motorized, pulley system (58).

Accordingly, the panel (51) moves along the z-axis, supported by the frame (52), to a position along the storage location (40) that holds a base (10); panel (51) then moves along the x-axis, outside of frame (52), to receive the base (10); panel (51) and base (10) move in the x-axis back into frame (52); next, the panel moves along the z-axis within the frame (52) to the transfer height; and, finally, the panel (51) moves along the x-axis (60), inside the frame, to deliver the base (10) to the main conveyor (20). In another embodiment, the panel (51) may move along the y-axis so as to receive a base (10) at an additional column or set of storage locations adjacent to the original storage location (40).

In another embodiment, the handler (50) is further comprised of a conveyor belt (60). Accordingly, a base (10) is received from its storage location, as described above, then the panel (51) may move along the z-axis to associate the base (10) with conveyor belt (60). According to an embodiment, conveyor belt (60) moves the base to the main conveyor belt (20).

In an exemplary sequence of events, a base (10) is conveyed to at least one: liquid distribution station where at least one layer of liquid is associated with the base (10); foodstuff distribution station (300) where foodstuff is associated with the base (10); or a combination thereof.

Referring to FIG. 1B, in an exemplary sequence of events, a base (10), pizza dough, is conveyed to a liquid distribution station (200) where at least one layer of pizza sauce is applied to the pizza dough (10). The pizza dough (10) may be raw, baked, or par-baked. The pizza dough may be formed as any shape or unformed. The pizza dough (10) then passes through the cheese distribution station (600) which deposits cheese onto the base (10). In a preferred embodiment, at the cheese distribution station (600) cheese is grated, sliced, cut, or otherwise sectioned before the cheese is associated with the pizza dough (10). However, if the cheese is pre-shredded, sliced, or otherwise cut, the cheese maybe delivered to the pizza dough (10) at the granular foodstuff distribution station (800) below.

The pizza dough (10) then proceeds to the meat distribution station (700) where meat is associated with the pizza dough (10). In a preferred embodiment, the meat distribution station (700) slices, cuts, or otherwise sections meat before the meat is deposited onto the pizza dough (10a). Subsequently, the pizza dough (10) passes through granular food distribution station (800). Foodstuffs like olives, green peppers, onions, artichoke hearts, cheese, amongst others, are associated with the pizza dough (10). In an embodiment, the pizza dough (10) with associated foodstuff and sauce is then conveyed to an oven or other heat source for cooking.

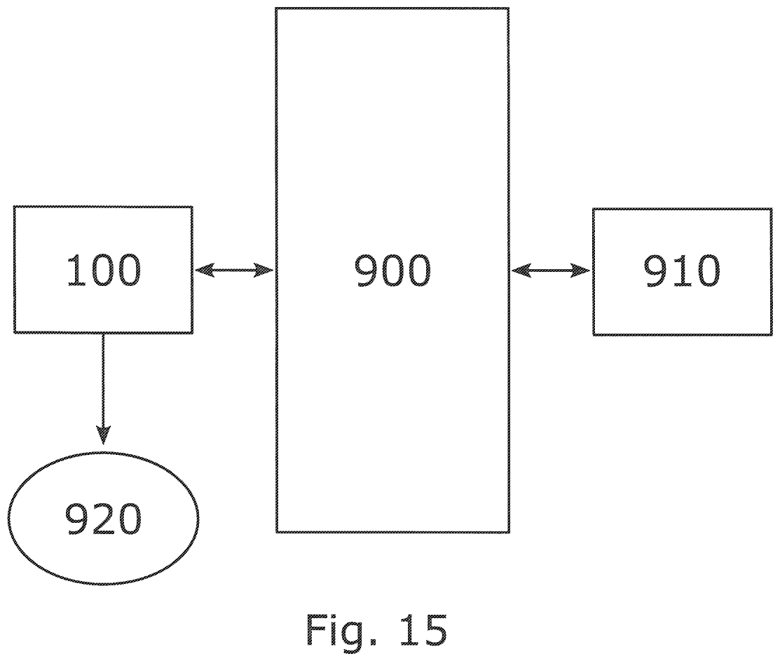

Referring to FIG. 15, in an exemplary embodiment, functions of the apparatus for a self-contained system to associate foodstuff and/or liquid with a base (100) communicates with software (900) that controls metering of liquid and/or foodstuff, recipe management, amongst others.

According to an embodiment, the apparatus for a self-contained system to associate foodstuff and/or liquid with a base (100) is comprised of at least a liquid distribution station (200) and a foodstuff distribution station (300). According to an embodiment, the apparatus (100) communicates with software (900) where the software (900) is a computer numerical control system. In some embodiments, each station (200, 300) is independently controlled by a separate computer numerical control system. In some embodiments, the computer numerical control system may send each station (200,300) a system objective, operation instructions, core instructions, or specific instructions to each station (200, 300).

In an embodiment, the apparatus for a self-contained system to associate foodstuff and/or liquid with a base (10) communicates with software that receives an order (910) from a user to associate foodstuff and/or liquid with a base (100). According to an embodiment, when an order is communicated with the apparatus (100), it associates the requested foodstuff and/or liquid with a base (10). In an embodiment, a user (920) receives a base with associated foodstuff and/or liquid.

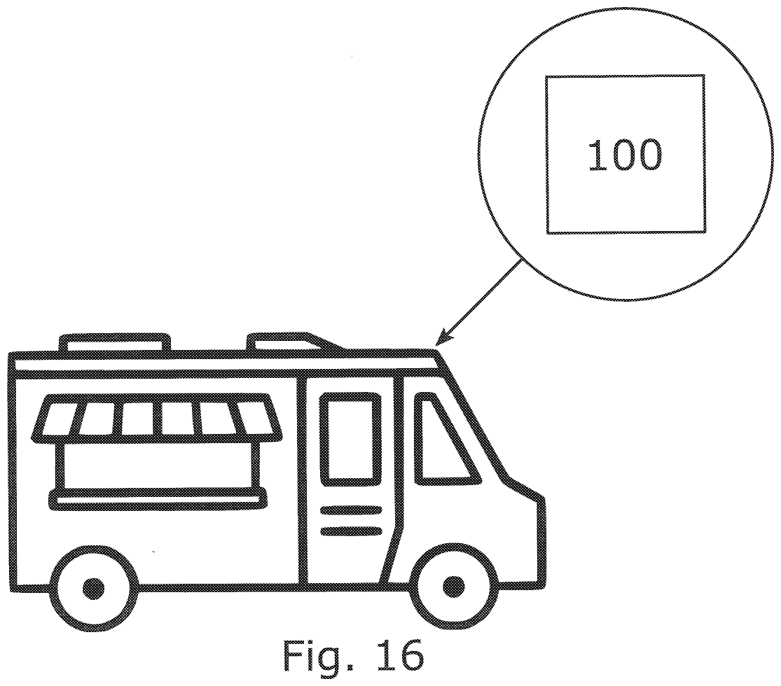

Referring to FIG. 16, according to an embodiment, the apparatus for a self-contained system to associate foodstuff and/or liquid with a base (10) is operably associated with a vehicle (70). According to an embodiment, the associated foodstuff and/or liquid is delivered to the user just as the apparatus (100) has completed associating foodstuff and/or liquid with a base (10). According to an embodiment, the apparatus (100), the base (10) and the associated foodstuff and/or liquid are cooked in the vehicle before delivery.

As will be appreciated by one skilled in the art, aspects of the software may be embodied as a system, method, or computer product. Accordingly, aspects of the software may take the form of an entirely hardware embodiment, entirely software embodiment (including firmware, resident software, micro-code, etc.), or an embodiment combining software and hardware aspects. Further aspects of the software may take the form of a computer program embodied in one or more readable mediums having computer readable program code/instructions thereon. Program code embodied on computer-readable medium may be transmitted using any appropriate medium, including but not limited to wireless, wireline, optical fiber cable, RF, etc., or any suitable combination of the foregoing. The computer code may be executed entirely on a user's computer; partly on the user's computer; as a standalone software package; a cloud service; partly on the user's computer and partly on a remote computer; or entirely on a remote computer, remote or cloud-based server.

We claim as our invention:

1. An apparatus to distribute liquid wherein, the apparatus is comprised of at least one liquid distribution guide, at least one conduit that provides liquid to at least one liquid distribution mechanism; whereby the liquid distribution mechanism is connected to the liquid distribution guide so as to allow movement of the liquid distribution mechanism along the liquid distribution guide; where the liquid distribution mechanism moves from at least one first location to at least one second location along the liquid distribution guide; wherein the liquid distribution mechanism delivers liquid to a base releasing liquid while in motion from a first location to a second location.

2. The apparatus of claim 1 where the first location and/or the second location, relative to the liquid distribution guide, may vary allowing liquid to be deposited in more than one pattern.

3. The apparatus of claim 1 wherein, the first location and/or the second location of the liquid dispensing mechanism, relative to the liquid distribution guide, is dependent on the size of a base, the location of the base, relative to the liquid distribution mechanism, the type of liquid being distributed over the base, or a combination thereof.

4. A system to associate foodstuff and/or liquid with a base is comprised of:
(a) a food transportation system; where the food transportation system conveys at least one base;
(b) at least one taken from the group consisting of:
(i) an apparatus to distribute liquid; where the apparatus is comprised of at least one liquid distribution guide, at least one conduit that provides liquid to at least one liquid distribution mechanism; whereby the liquid distribution mechanism is connected to the liquid distribution guide so as to allow movement of the liquid distribution mechanism along the liquid distribution guide; where the liquid distribution mechanism moves from at least one first location to at least one second location along the liquid distribution guide; wherein the liquid distribution mechanism delivers liquid to a base releasing liquid while in motion from a first location to a second location;
(ii) an apparatus to distribution foodstuff; where the apparatus is a delta robot where the delta robot is comprised of at least one camera; where the camera detects the base and determines the size and shape of the base; where the delta robot compares the size and/or shape of the base against a known size and/or shape; where the delta robot calibrates placement of foodstuff relative to the comparison.

5. The system of claim 4, where the foodstuff transportation system is chilled or heated.

6. The system of claim 4 where the foodstuff transportation system lies approximately perpendicular to apparatus to distribute liquid and/or the apparatus to distribute foodstuff.

7. The system of claim 6 where the foodstuff transportation system may incline or decline the base to receive liquid and/or foodstuff.

8. The system of claim 4 where the apparatus to distribute liquid first location and/or the second location, relative to the liquid distribution guide, may vary allowing liquid to be deposited in more than one pattern.

9. The system of claim 4 where the apparatus to distribute liquid first location and/or second location, relative to the liquid distribution guide, is dependent on the size of the base, the location of the base, the type of liquid being distributed over the base, or a combination thereof.

10. A method to associate foodstuff and/or liquid to a base comprised of:
(a) a food transportation system;
(b) an apparatus to distribute liquid; where the apparatus is comprised of at least one liquid distribution guide, at least one conduit that provides liquid to at least one liquid distribution mechanism; whereby the liquid distribution mechanism is connected to the liquid distribution guide so as to allow movement of the liquid distribution mechanism along the liquid distribution guide; where the liquid distribution mechanism moves from at least one first location to at least one second location along the liquid distribution guide; wherein the liquid distribution mechanism delivers liquid to a base releasing liquid while in motion from a first location to a second location;
(c) an apparatus to distribution foodstuff; where the apparatus is a delta robot where the delta robot is comprised of at least one camera; where the camera detects the base and determines the size and shape of the base; where the delta robot compares the size and/or shape of the base against a known size and/or shape; where the delta robot calibrates placement of foodstuff relative to the comparison.
(d) a base is conveyed on the food transportation system to at least the one apparatus to distribute liquid or one apparatus to distribute foodstuff.

11. The method of claim 10, where the foodstuff transportation system is chilled or heated.

12. The method of claim 10 where the foodstuff transportation system may incline or decline the base to receive liquid and/or foodstuff.

13. The method of claim 10 where the apparatus to distribute liquid first location and/or the second location, relative to the liquid distribution guide, may vary allowing liquid to be deposited in more than one pattern.

14. The method of claim 10 where the apparatus to distribute liquid first location and/or second location, relative to the liquid distribution guide, is dependent on the size of the base, the location of the base, the type of liquid being distributed over the base, or a combination thereof.
